(19) United States
(12) Patent Application Publication
(10) Pub. No.: US 2025/0069033 A1
(43) Pub. Date: Feb. 27, 2025

(54) RETAIL SHELF MONITORING SYSTEM AND METHOD

(71) Applicant: SHELFIE TECH LTD., Tel Aviv (IL)

(72) Inventor: Bentsur JOSEPH, Tel Aviv (IL)

(21) Appl. No.: 18/688,342

(22) PCT Filed: Aug. 29, 2022
(86) PCT No.: PCT/IL2022/050942

§ 371 Date: Feb. 29, 2024

Related U.S. Application Data
(60) Provisional application No. 63/238,163, filed on Aug. 29, 2021.
(60) Provisional application No. 63/303,178, filed on Jan. 26, 2022.

(51) Int. Cl. G06Q 10/087; G06V 20/52

(52) U.S. Cl. CPC G06Q 10/087; G06V 20/52

(57) ABSTRACT

The present invention provides an innovative method and system for monitoring a retail shelf supply, which is designed to monitor retail shelves in real-time to ensure inventory control, product availability, etc.

### FIELD OF THE INVENTION

The present invention relates to the field of retail shelf supply, and in particular to monitoring systems for retail shelf supply designed to monitor retail shelves in order to ensure inventory control, product availability, etc.

### BACKGROUND

In all retail stores where products for sale are displayed and made readily available upon shelves, it is important that restocking of shelves be effected before or immediately upon exhaustion of the product from the shelf. Indeed, since product turnover equates to profit in most retail stores, the ability to monitor on-shelf inventory and product availability is paramount. It is further desirable that such systems include the ability to alert the retail store management with regard to out of stock situations so that corrective action can be taken as soon as possible. In addition, the ability to monitor sales activities based on days of the week is another important capability to enhance sales activities.

One of the main costs in retail stores operation relates to inventory management, which includes the tracking and storing of inventory, which includes product inventory management in the selling area, from which periodic counting of product on the store shelves takes a big part. This counting is necessary to determine the amount of product on the shelves and to help ensure the shelves are fully stocked.

Today, the counting of inventory on store shelves is done manually. Recent development provide manual computerized counting, and transmitting the counts to a central computer that compiles data and makes decisions regarding the purchase of products for restocking the shelves. However, this still requires significant manual labor. It would be beneficial to reduce the amount of manual labor required to count the inventory.

Another problem raises from the fact that shelves in retail stores are often adjusted, moved, repositioned, or stocked with different products from time to time. Accordingly, the adaptability of retail shelf supply monitoring systems is important to effective operation. Over any course of time, the product available on any particular shelf, or the location of that shelf itself, may vary within the retail store, and as such any shelf-monitoring system must be capable of continuing effective monitoring throughout changeover.

Methods and systems for automatic monitoring of retail shelves are described, e.g., in U.S. Pat. Nos. 7,792,711 and 8,260,456. However, these system are designed for immediate identification of the removal of an item from the shelf and thus require complicated assemblies positioned at each shelf, each assembly fitting specific item.

Moreover, many retail stores refrain from using computerized shelf monitoring systems due to high-cost, complexity of assembly on adjustable shelves, electricity & communication requirements, etc.

Accordingly, a need exists for efficient, cost effective and easily adjustable shelf monitoring systems.

### SUMMARY

The present invention provides an automatic inventory shelf monitoring system for monitoring products' inventory on a shelf unit (300), comprising: (a) a digital image capturing system designed to capture an image of all product on all shelfs within said shelf unit (300); (b) a transportation system designed to move said image capturing system along said shelf unit (300); and (c) a computerized system comprising a processor and a memory, wherein: (i) said transportation system is mounted on said shelf unit (300); and (ii) said computerized system is designed to receive images taken by said image capturing system, analyze same, determine the number of units and/or the exact location of each product residing on each shelf of said shelf unit (300), and providing an output thereof.

### BRIEF DESCRIPTION OF DRAWINGS

For a better understanding of various embodiments of the invention and to show how the same may be carried into effect, reference will now be made, by way of example, to the accompanying drawings, in which:

FIGS. 1A-1B are illustration of an exemplary shelf monitoring system according to the invention.

FIGS. 2A-2G are illustration of another exemplary shelf monitoring system according to the invention having two rails.

FIGS. 3A-3H are illustration of another exemplary shelf monitoring system according to the invention having a single rail.

FIG. 4 is an illustration of an exemplary shelf monitoring system according to the invention.

FIG. 5 is an illustration of an exemplary shelf monitoring system according to the invention mounted onto a shelf array within a retail store.

FIG. 6 is an illustration of how several individual images are combined into a single panoramic image.

### DETAILED DESCRIPTION

Monitoring shelves' content/stock is a vital task in any retail store/establishment in order to maintain sufficient stock for consumers. Today, this task is carried out manually by employees, usually towards the end of the working day as preparation for the next day and for preparing an ordering list of items that needs to be re-stocked.

Accordingly, the present invention provides a system and method for automatic monitoring of shelves for identifying whether certain items need to be re-filled or ordered for re-stocking.

Specifically, the invention provides an automatic inventory shelf monitoring system for monitoring products' inventory on a shelf unit (300), comprising: (a) a digital image capturing system designed to capture an image of all product on all shelfs within said shelf unit (300); (b) a transportation system designed to move said image capturing system along said shelf unit (300); and (c) a computerized system comprising a processor and a memory, wherein: (i) said transportation system is mounted on said shelf unit (300); and (ii) said computerized system is designed to receive images taken by said image capturing system, analyze same, determine the number of units and/or the exact location of each product residing on each shelf of said shelf unit (300), and providing an output thereof.

The term “shelf unit” as used herein refers to a display system comprising one or more shelves. The shelf unit may be a fixed unit, i.e. cannot be easily moved around, or shiftable, i.e. can be easily moved from one place to the other. The shelf unit may be rigid, i.e. with fixed unmovable shelves, or flexible, i.e. with shelves that can be easily rearranged and adjusted to accommodate different product dimensions. An exemplary shelf unit is a gondola, which is an island shelving unit open on two sides. In some cases, the top shelf over a shelving unit, known as a riser, is used to house overstocks, but not necessarily.

The digital image capturing system according to the invention is designed to capture images of all the products residing on each shelf in the shelf unit (300). Any suitable image capturing unit/instrument can be used, such as digital still cameras, digital video camera, color or black & white, etc.

In certain embodiments of the digital image capturing system according to any of the embodiments above, when the image capturing unit/instrument is a digital still image capturing unit/instrument(s) at every defined distance and/or time. For instance, the system can be designed to capture an image every 1, 2, 3, 4, 5, 6, 7, 8, 9, 10 or more seconds. Alternatively, or in addition, the system is designed to capture an image every 5, 10, 15, 20, 25, 30, 35, 40, 45, 50, 55, 60, 65, 70, 75, 80, 85, 90, 95, 100 or more cm. This enables the system to obtain overlapping sections of the images to ensure complete covering of the scanned shelf.

In specific embodiments, the digital image capturing system further comprises a radar sender and receiver; an ultrasound sender and receiver; or an X-ray sender and receiver. These additions enable the image capturing system to emit a signal (radar, sound or X-ray, respectively) and then capture the returning/reflected signal to thereby enable identifying rear-located units of products that are otherwise hidden from a regular optic camera.

Another alternative is that the digital image capturing system according to the invention further comprises an RF reader designed to receive RF signals from RF emitters located on each product. This enables easy identification of the product type. In further specific embodiments, the digital image capturing system comprises only of RF reader(s) as an image capturing unit, wherein the identification and determination of amount/number of product units on each shelf is carried out by receiving RF signals from each item as the image capturing unit passes by. In this way, there is no need to scan barcode or analyze an image by an AI to determine the type of product, and there is no need to use means to detect items located in the back. However, it does require that all the items be marked with a RF emitter.

The identification of each product on each shelf and at each location on the shelf can be done in any suitable way. For instance, the image capturing system may take an image of a barcode on each product (or of a barcode at a respective location on the shelf), which enables identification of the product by the computerized system. Alternatively, the image capturing system may further comprise a barcode reader. Another option is that the computerized system is an Artificial Intelligence (AI) that can identify the products according to their image taken by the image capturing system. As such, the automatic inventory shelf monitoring system according to the invention can identify which product is on each part of all the shelves of the shelf unit (300), and can determine the amount/number of units of each product.

Alternatively, the system is not designed to identify the type of product, but only to count the amount of units residing on each shelf, wherein the type of product is pre-inputted into the computerized system by a user. This might be required when the products have no distinctive markings, such as cardboard boxes with minimal writings indicating their contents.

In certain embodiments, the automatic inventory shelf monitoring system according to any of the embodiments above, is designed to scan the shelf periodically, e.g. every morning before opening and/or every night after closing. Alternatively, or in addition, the system can be manually activated, thereby enabling the user to scan a shelf upon demand. For instance, when a product is in sale, the shop manger would like to know the status of the remaining amount of the product so that it can be restacked/refilled.

The automatic inventory shelf monitoring system of the invention is designed to scan the entire length of the shelves within a shelve unit. This is enabled by using an adjustable transportation system that is assembled/mounted directly onto the shelf unit (300). This enables using the system anywhere regardless of the location and position of the shelf unit (300) in the retail store. In addition, the fact that the transportation system is adjustable, means that it can be adapted/adjusted to fit any shelf unit (300) in terms of number of shelves, height and length.

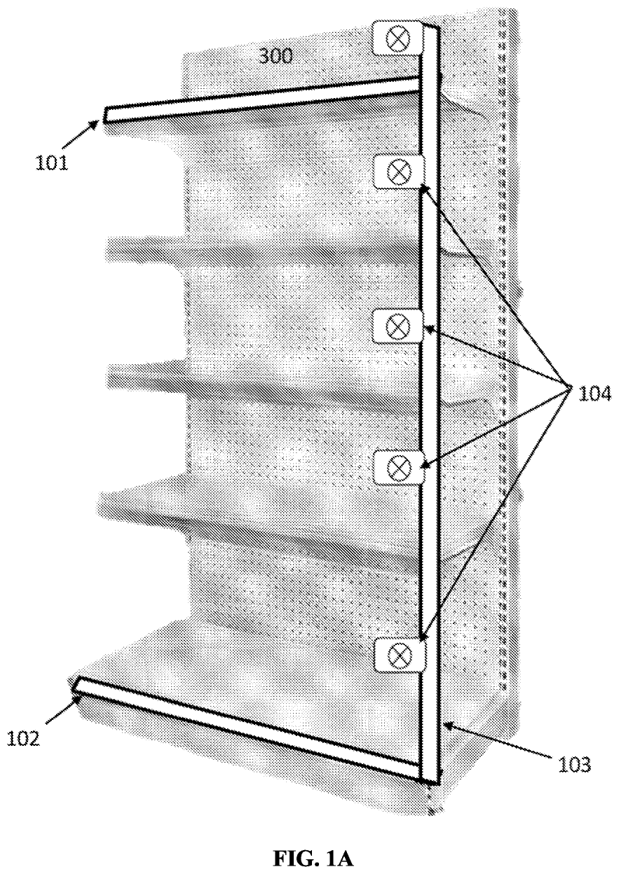

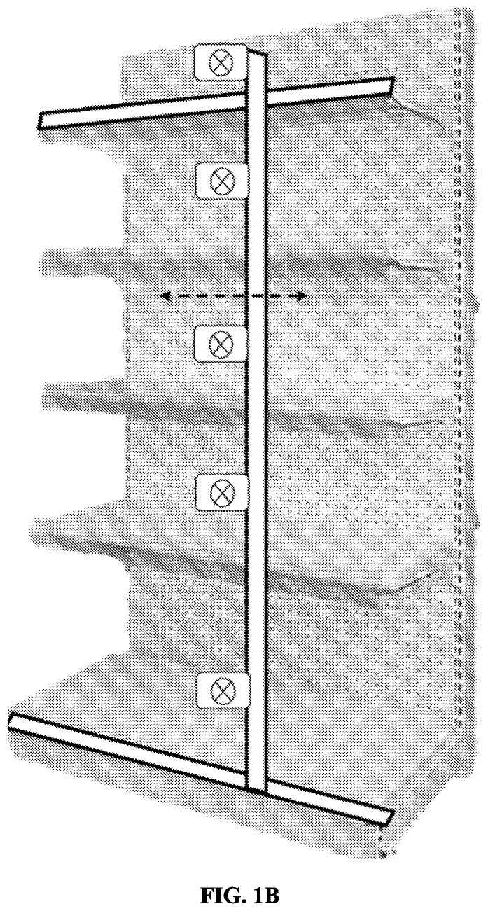

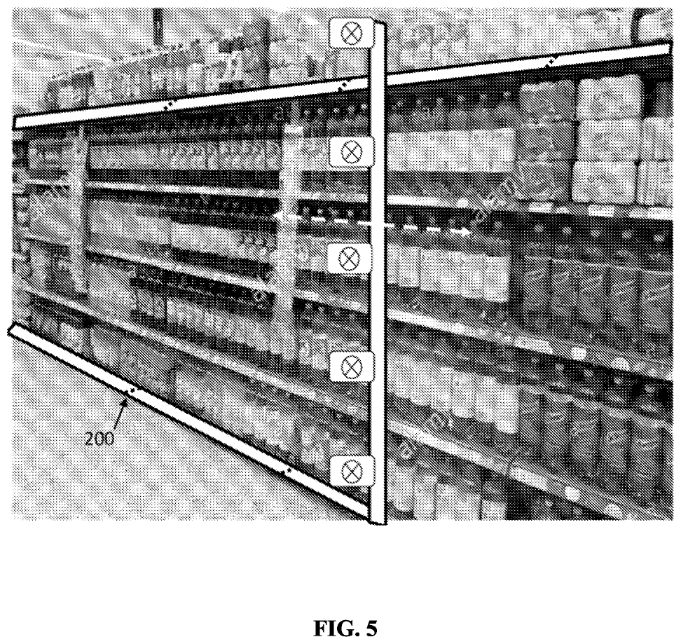

For instance, as illustrated in FIGS. 1A-1B, the transportation system may comprise an upper rail (101) and a lower rail (102) onto which a bar (103) holding the image capturing system. The length of the upper-and lower rails (101), (102) is determined according to the length of the shelves. In specific embodiments, several pieces of rails can be joined together to reach the entire length of the shelves (see illustrated by the dotted lines (200) along the rails in FIG. 5). The number of rails (101), (102) in the system according to the invention can vary and can be from a single rail (101) mounted onto, e.g., the top shelf (or the second from the top); two rails (101), (102), mounted onto, e.g., the top and the bottom shelves (or any other shelves according to comfort); three rails, or rails according to the number of shelves (i.e. a rail is mounted on each shelf). Preferably, only one or two rails are used to reduce costs and simplify assembly of the system on the shelf unit (300).

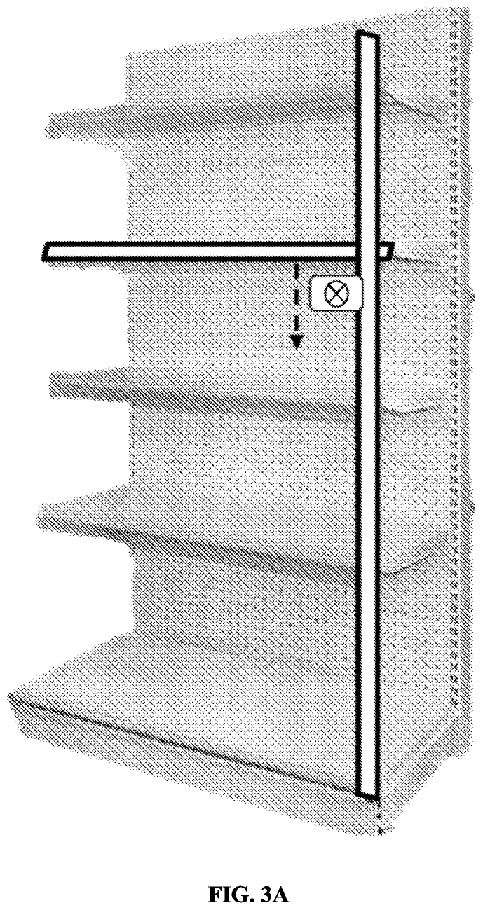

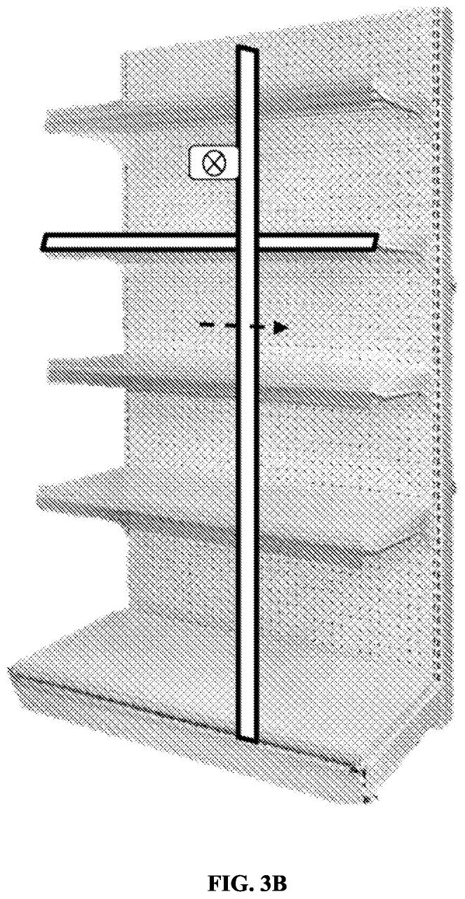

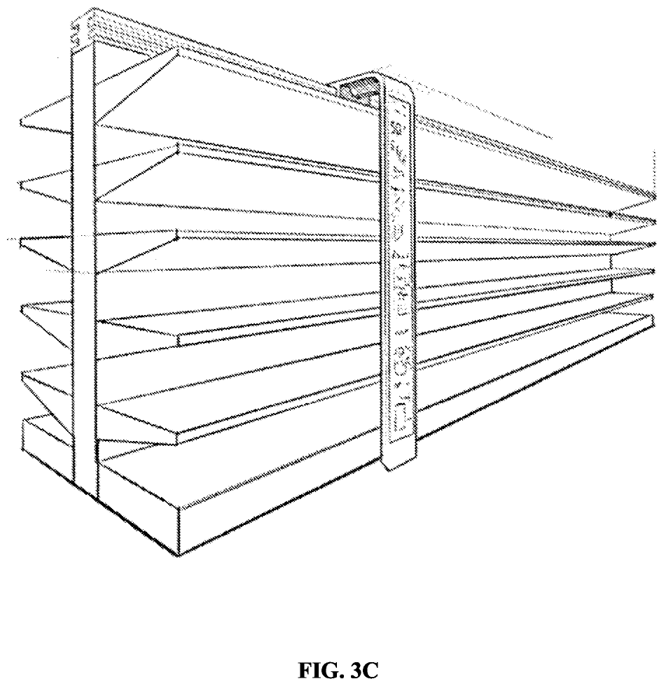

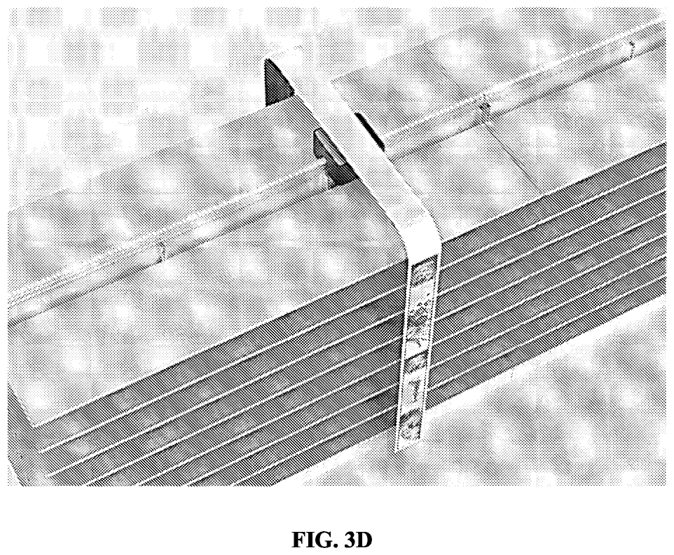

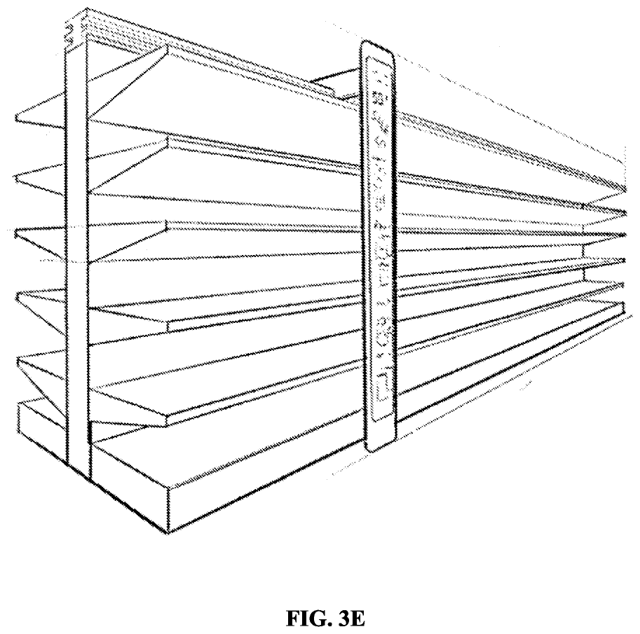

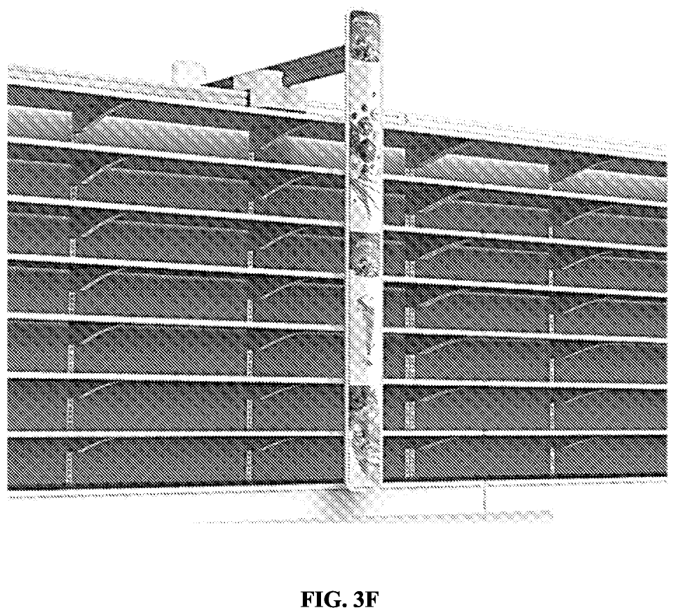

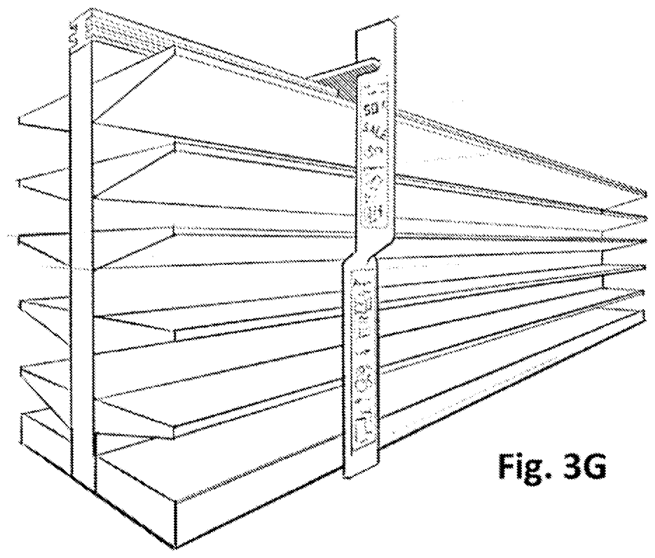

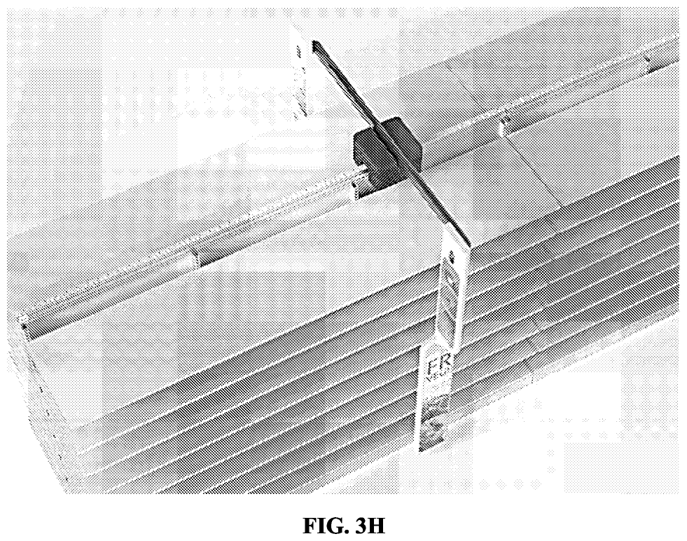

FIGS. 3A-3H illustrate various possibilities of a single-rail transportation system according to the invention: FIGS. 3A and 3B illustrate a single-rail located at one of the shelves and carrying the image capturing unit(s); FIGS. 3C-3H illustrate a single-rail located at the top upper section of the shelves, which enables using a single transportation system for moving bars (103) on both sides of the shelf unit (300) to cover shelves on both sides thereof. The bar (103) may comprise a single image capturing unit that moves up & down on the bar, or multiple image capturing units for each shelf in the unit (300). As illustrated, the shape of the bar can vary according to need and desire and can be further used to present commercials, product's details, and/or prices, etc., or any combination thereof.

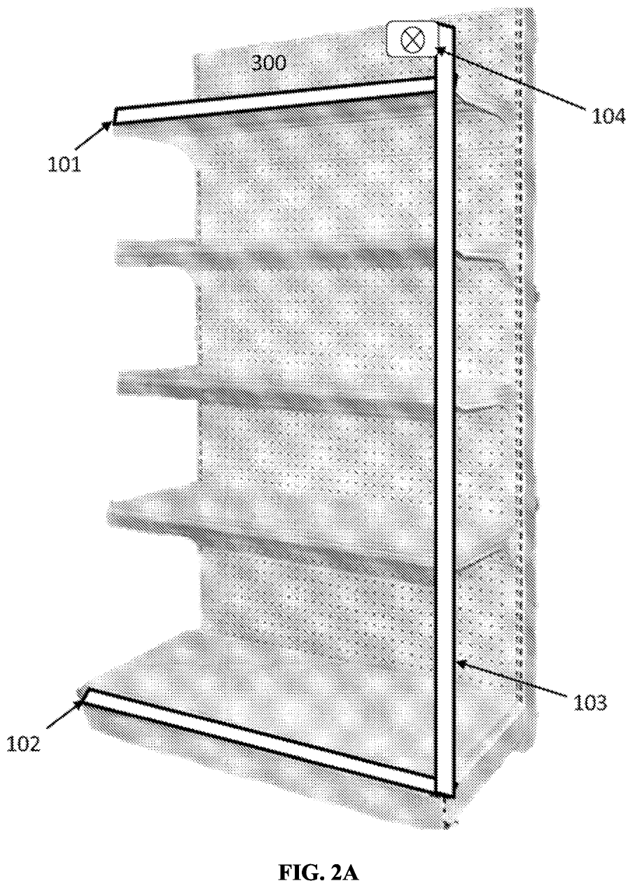

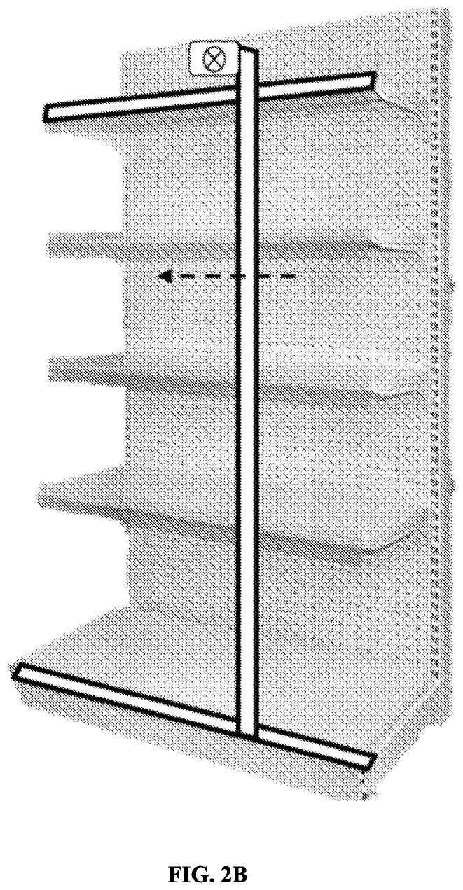

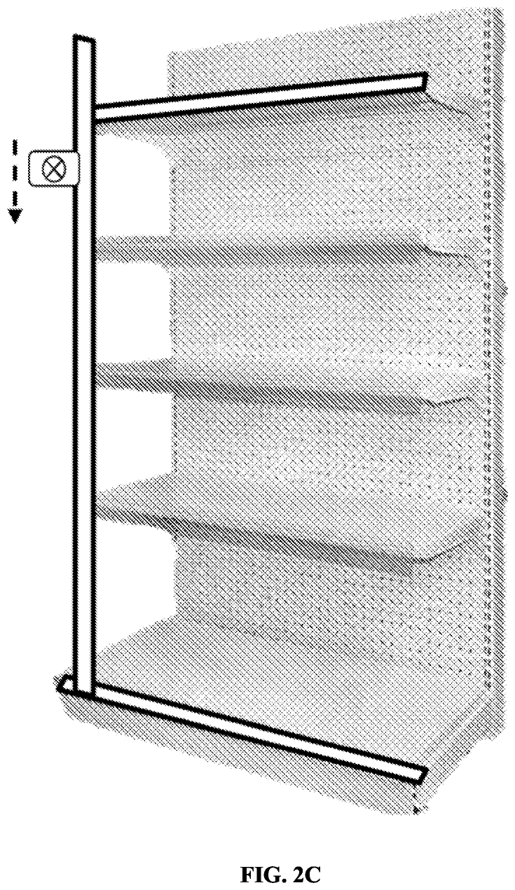

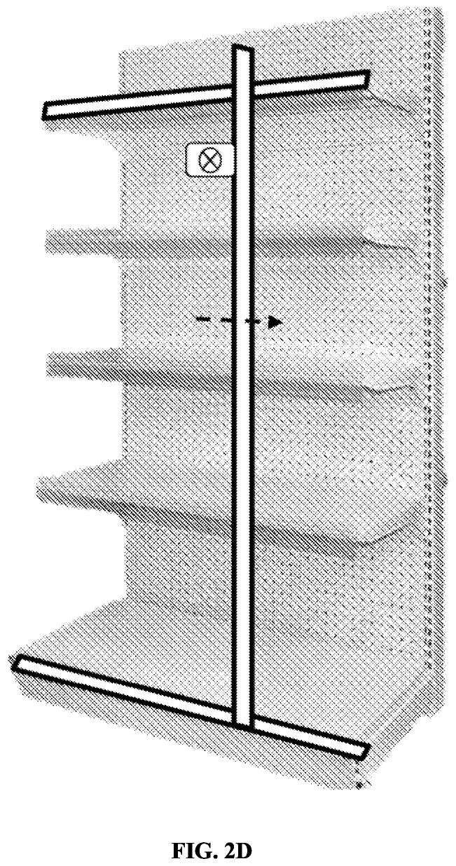

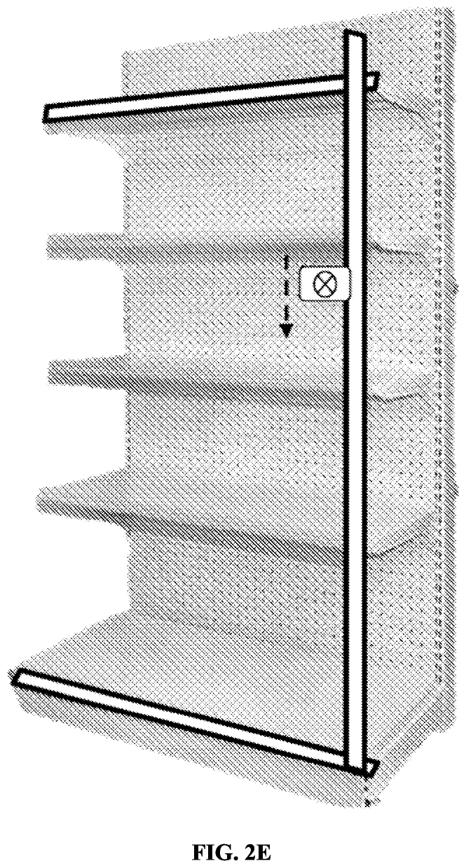

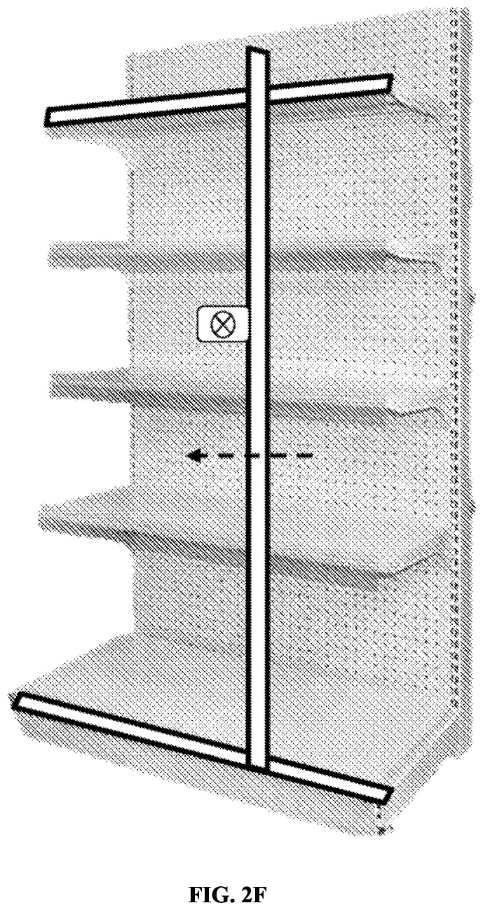

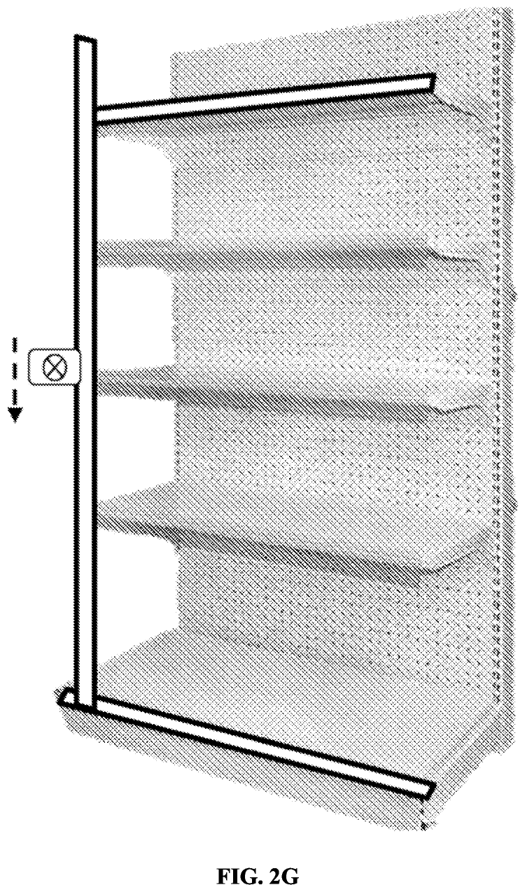

The transportation system according to the invention is designed to move the image capturing system along the entire length of the shelves in the shelf unit (300). This is done by mounting the image capturing units (104) onto, e.g., a bar (103) that is movable along the rails (101), (102). The bar (103) is moved by any suitable mechanism, such as an electric motor and a set of wheels/gears connected-to and rolled by the motor. FIGS. 1B and 2B, illustrate how a bar (103) with an image capturing unit(s) (104) mounted thereon is moved right and left along the shelves of the shelf unit (300), thereby passing the image capturing unit(s) (104) over all the items/products placed on the shelves.

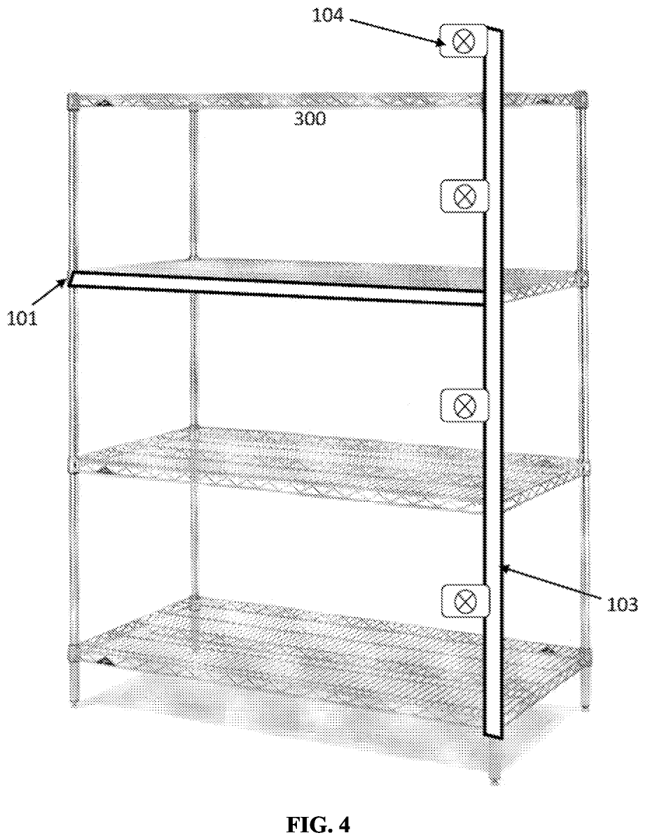

In certain embodiments, the image capturing system comprises a plurality of image capturing units (104), e.g. cameras, each unit (104) is assigned to a different shelf within said shelf unit (300). FIGS. 1A-1B, 4 and 5 illustrate such a system, in which the number of image capturing units (104) equals the number of shelves in the shelf unit (300). In such a configuration, a single pass of the bar (103) from right to left (or vise-versa) is sufficient to identify and count all the product items residing on all the shelves of the shelf unit (300). In specific embodiments, the system can be configured to move to one side and stop on the other, and start from the other side when commencing another count. Alternatively, the system may be designed to conduct two runs-back and forth-to bring the bar (103) to its original location after each count.

In alternative embodiments, the image capturing system does not comprise image capturing units (104) in accordance with the number of shelves in the shelf unit (300), or it comprises only a single image capturing unit (104). In such a configuration, the transportation system is further designed to move such image capturing unit (104) up and down to enable the system to scan all the shelves within the shelf unit (300). As illustrated in FIGS. 2A-2G, in a first run of the bar (103) to the left, the image capturing unit (104) is positioned at the top for scanning the top shelf. However, before the bar (103) returns right, the image capturing unit (104) is lowered to the next shelf and scan it as the bar (103) returns right. Then, the image capturing unit (104) is lowered again and the bar (103) is moved to the left, and so forth, until all the shelves have been scanned. Alternatively, the bar (103) can be moved left and right to scan one shelf (once or twice) and only then the image capturing unit (104) is lowered for scanning the next shelf, and so forth. Although the figures and explanations above refer to movement from top to bottom, it is to be understood that the movement of the image capturing unit (104) can be from bottom to top.

The image capturing unit(s) (104) transfers image data to the computerized system, which is designed to identify individual units of the product(s) within each shelf. The identification is carried out by any suitable means, such as use of a barcode reader reading a barcode on each unit, an RF reader reading a RF transmitter on each unit, an AI that identifies and separates between individual units of the same product, etc. Once the computerized system determines the amount of items of each product on the shelf, it calculates the required amount of items that needs to be added in order to restock each shelf and provides a user with an output indicating the required amount of units of each product that is required for refilling/restocking the shelf unit (300).

In specific embodiments, the computerized system is further designed to identify the product type, e.g., via its barcode or by comparing the image to an existing database, pre-inputted to the memory.

In certain embodiments of the automatic inventory shelf monitoring system according to any of the embodiments above, the computerized system is further designed to generate/reproduce from received images captured by said digital image system, a single image (e.g. a panoramic image) of the entire shelf for each shelf in said shelf unit (300). The number of images used to generate/reproduce such a single image can vary and can be any number of images, such as 2, 3, 4, 5, 10, 15, 20, 25, 30 or more. The generated/reproduced single image unifies multiple single images taken from different positions and/or cameras along the shelf into a single image. The single image can be, e.g., a panoramic image or a planogram image. The term “planogram” relates to an image that has undergone registration, namely adaptation to an existing image or blueprint.

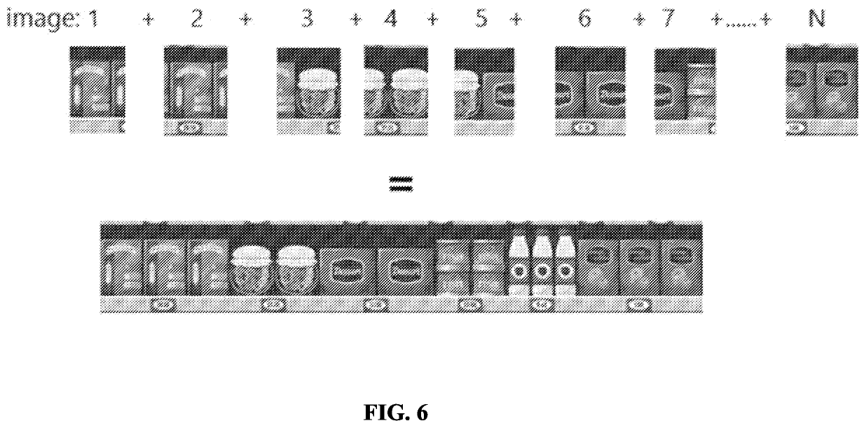

FIG. 6 illustrates how the system of the invention can take several individual images, taken from different positions/angles along a single shelf, and combine them into a single panoramic image representing the entire length of a shelf with all the items residing thereon.

Accordingly, in specific embodiments of the automatic inventory shelf monitoring system according to any of the embodiments above, the single image is a panoramic image. In further or alternative embodiments, the computerized system is further designed to analyze said generated single image or panoramic image (instead of said received images).

The computerized system may be an integral part of the automatic inventory shelf monitoring system and implemented within the shelf unit (300). Alternatively, the computerized system may be assembled away from the shelf unit (300) and receive data from said image capturing system either wirelessly or via wires.

In certain embodiments, the digital image capturing system according to any of the embodiments above, further comprises at least one person/people-detection unit, such as a camera, a motion detector, a body-heat sensor, a scale, etc., designed to identify the presence of a person (or some) that is standing in front or near the shelf. The people-detection unit can be an integral part of the system and be mounted, e.g., on the rails similar to the digital image capturing system or transportation system, or be separated therefrom, such as mounted on the ceiling or floor. In certain embodiments, a single people-detection unit may be used for multiple automatic inventory shelf monitoring systems. In such a case, the computerized system is further designed to receive data from said people-detection unit and determine, according to the data obtained therefrom, whether one or more persons/individuals are standing in-front or in vicinity to the shelf. Then, the computerized system can determine whether or not to start the operation of the monitoring system: for instance, if the computerized system determines that a person is standing near the shelf, it may delay the activation of the shelf scanning system until it identifies that no people/individuals are standing in-front or in vicinity to the shelf. This is aimed to prevent a situation in which the system scans a shelf and interfere with the shopping experience of nearby shoppers.

In certain embodiments, each shelf unit (300) is associated with an independent computerized system. In alternative embodiments, a single computerized system is used for multiple image capturing systems each mounted on a different shelf unit, thereby enabling monitoring products' inventory on all the shelf units (300) within a retail store using a single computerized system.

The automatic inventory shelf monitoring system may receive power from the main power grid, or may have an integral power source, such as a battery or solar panels, etc.

Structural details of the invention are shown to provide a fundamental understanding of the invention, the description, taken with the drawings, making apparent to those skilled in the art how the several forms of the invention may be embodied in practice.

It is to be understood that the embodiments described hereinabove are cited by way of example, and that the present invention is not limited to what has been particularly shown and described hereinabove. Computer processing elements described may be dedicated and/or distributed processing elements, implemented over wired and/or wireless networks. Such computing systems may furthermore be implemented by multiple alternative and/or cooperative configurations, such as mobile devices, a data center server or a cloud configuration of processers and data repositories. Processing elements of the system may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or distributed across multiple sites. Memory storage may also include multiple distributed memory units, including one or more types of storage media.

Communications between systems and devices described above are assumed to be performed by software modules and hardware devices known in the art. Processing elements and memory storage, such as databases, may be implemented so as to include security features, such as authentication processes known in the art.

Method steps associated with the system and process can be rearranged and/or one or more such steps can be omitted to achieve the same, or similar, results to those described herein.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

1. An automatic inventory shelf monitoring system for monitoring products' inventory on a shelf unit (300), comprising:
a) a digital image capturing system designed to capture an image of all product on all shelfs within said shelf unit ((300));
b) a transportation system designed to move said image capturing system along said shelf unit (300); and
c) a computerized system comprising a processor and a memory,
wherein:
said transportation system is mounted on said shelf unit (300); and
said computerized system is designed to receive images taken by said image capturing system, analyze same, determine the number of units and/or the exact location of each product residing on each shelf of said shelf unit (300), and providing an output thereof.

2. The automatic inventory shelf monitoring system of claim 1, wherein said image capturing system further comprises a radar sender and receiver designed to capture reflected radar signals to identify rear-located units of products.

3. The automatic inventory shelf monitoring system of claim 1, wherein said image capturing system further comprises a barcode reader or is configured to read such a barcode.

4. The automatic inventory shelf monitoring system of claim 1, wherein said image capturing system comprises an RF reader, in addition or instead of an image capturing unit.

5. The automatic inventory shelf monitoring system of claim 1, wherein said transportation system comprises a single rail (101) along the shelf unit (300) onto which said image capturing system moves.

6. The automatic inventory shelf monitoring system of claim 1, wherein said transportation system comprises two rails (101), (102) along the shelf unit (300) designed to provide greater support for said image capturing system as it moves along.

7. The automatic inventory shelf monitoring system of claim 1, wherein said image capturing system comprises a plurality of image capturing units (104), e.g. cameras, each unit (104) is assigned to a different shelf within said shelf unit (300).

8. The automatic inventory shelf monitoring system of claim 1, wherein said image capturing system comprises a single image capturing unit (104), e.g. a camera, and said transportation system is further designed to move said image capturing unit (104) up and down thereby enabling scanning all the shelves within the shelf unit (300).

9. The automatic inventory shelf monitoring system of claim 1, wherein said computerized system is designed to activate the system periodically according to a predefined schedule.

10. The automatic inventory shelf monitoring system of claim 1, wherein said computerized system further provides an output indicating a required amount of units of each product that is required for refilling/restocking the shelf unit (300).

11. The automatic inventory shelf monitoring system of claim 1, wherein said computerized system is further designed to identify the product type, e.g., via its barcode or by comparing the image to an existing database.

12. The automatic inventory shelf monitoring system of claim 1, wherein said computerized system is further designed to generate/reproduce from received images captured by said digital image system, a single image of the entire shelf for each shelf in said shelf unit (300).

13. The automatic inventory shelf monitoring system of claim 12, wherein said single image is a panoramic image.

14. The automatic inventory shelf monitoring system of claim 12, wherein said computerized system is further designed to analyze said generated single image or panoramic image.

15. The automatic inventory shelf monitoring system of claim 1, wherein the system can be activated manually according to need.

16. The automatic inventory shelf monitoring system of claim 1, further comprising at least one people-detection unit, wherein the computerized system is further designed to receive data from said people-detection unit and determine whether one or more persons are standing in-front or in vicinity to the shelf, and activate the system only when it identifies that no person is standing in-front or in vicinity to the shelf.

17. The automatic inventory shelf monitoring system of claim 13, wherein said computerized system is further designed to analyze said generated single image or panoramic image.
